(19) United States
(12) Patent Application Publication
(10) Pub. No.: US 2026/0006099 A1
(43) Pub. Date: Jan. 1, 2026

(54) ENHANCED EDGE NETWORK MANAGEMENT

(71) Applicant: Samsung Electronics Co., Ltd., Gyeonggi-do (KR)

(72) Inventor: Deepanshu GAUTAM, Bangalore (IN)

(21) Appl. No.: 18/881,482

(22) PCT Filed: Jul. 10, 2023
(86) PCT No.: PCT/KR2023/009751

§ 371 Date: Jan. 6, 2025

(30) Foreign Application Priority Data
Jul. 8, 2022 (IN) 202241039255
Jun. 5, 2023 (IN) 202241039255

(51) Int. Cl. H04L 67/51; H04L 67/10

(52) U.S. Cl. CPC H04L 67/51; H04L 67/10

(57) ABSTRACT

The disclosure relates to a 5G or 6G communication system for supporting a higher data transmission rate. Embodiment herein provide a method performed by a service provider (SP) in an edge network. The method comprises transmitting, to an edge enabler server (EES), a request message for edge application server (EAS) discovery failure performance measurement; receiving, from the EES, a response message including at least one parameter associated with the EAS discovery failure performance measurement; determining whether an instantiation of the EAS is needed or not based on the at least one parameter; and performing instantiation of the EAS in case that the instantiation of the EAS is needed.

### TECHNICAL FIELD

The present disclosure relates to a wireless communication system, and more specifically to enhanced edge network management for handling Edge Application Server (EAS) discovery failure requests at an Edge Enabler Server (EES).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

An edge computing network can include an EES, an EAS and a Management Server, an edge computing device. The EES is a component that enables edge devices to communicate with the edge computing network. The EES provide a runtime environment and Application Programming Interface (APIs) for the edge devices to connect and send data to the edge computing device. The EAS is a server component of the edge computing device or edge computing network that processes the data sent from edge devices. The management server provides a communication layer for the edge devices. The EAS processes the data and runs applications. Further, the management server provides centralized management and monitoring of the edge computing network. The edge computing is realized in a mobile environment such as 5G systems, and is expected to provide more powerful computing power with a low latency.

In a 3^{rd} Generation Partnership Project (3GPP) an architecture for enabling edge computing that specifies an application framework or an enabling layer platform to support edge computing in 3GPP specified networks, (for instance discovery of edge services, authentication of the clients and the like) is described. The edge computing network includes interactions between a User Equipment (UE) and the Base Station (BS) or edge computing network, and the interactions between the applications deployed over the edge computing device and the enabling layer platform (can be referred as EES). The EAS or an Edge Application is deployed on a virtual infrastructure at the edge of the 3GPP network. As per current Edge Application Architecture, an Application client sends an EAS discovery request to the EES in order to find an appropriate EAS on an Edge Data Network (EDN). The EES determines appropriate EAS and return with EAS identifier and point of contact. The existing mechanism of an edge application layer architecture requires EES to trigger or request for the instantiation of the EAS as a result of a failed EAS Discovery procedures. The failed EAS discovery requires interaction with an edge network management system. The existing edge network management system lacks the ability for the EES to trigger or request for an EAS Instantiation.

### DISCLOSURE OF INVENTION

### Technical Problem

The principal object of the embodiments herein is a method for an EES to trigger or request for instantiation of an EAS as a result of a failed EAS discovery procedures. This requires interaction with network management system.

Another object of the embodiments herein is to instantiate the EAS directly by determining a list of dynamic EAS and modifying the EAS request and response based on the dynamic EAS.

Another object of the embodiments herein is to discover performance measurements to facilitate the EAS instantiation.

Another object of the embodiments herein is to notify ECSP for the need of EAS instantiation by defining new notifications.

Another object of the embodiments herein is to notify ECSP for the need of EAS instantiation using existing notifyEvent notification.

### Solution to Problem

According to at least one embodiment of the disclosure, a method performed by a service provider (SP) in an edge network is provided. The method comprises transmitting, to an edge enabler server (EES), a request message for edge application server (EAS) discovery failure performance measurement; receiving, from the EES, a response message including at least one parameter associated with the EAS discovery failure performance measurement; determining whether an instantiation of the EAS is needed or not based on the at least one parameter; and performing instantiation of the EAS in case that the instantiation of the EAS is needed.

In an embodiment, the at least one parameter includes subcounter of a user equipment (UE) location.

In an embodiment, the at least one parameter includes a number of EAS discovery failures.

In an embodiment, the number of EAS discovery failures is incremented on transmission of EAS discovery response indicating EAS discovery failure.

In an embodiment, the at least one parameter includes DIS.EasDisFail.Filter, wherein the DIS.EasDisFail.Filter is associated with the EAS discovery filter.

According to at least one embodiment of the disclosure, a service provider (SP) in an edge network is provided. The SP comprises a memory and a processor. The processor is configured to transmit, to an edge enabler server (EES), a request message for edge application server (EAS) discovery failure performance measurement, receive, from the EES, a response message including at least one parameter associated with the EAS discovery failure performance measurement, determine whether an instantiation of the EAS is needed or not based on the at least one parameter, and perform instantiation of the EAS in case that the instantiation of the EAS is needed.

According to at least one embodiment of the disclosure, a method performed by an edge enabler server (EES) in an edge network is provided. The method comprises performing edge application server (EAS) discovery; receiving, from a service provider (SP), a request message for EAS discovery failure performance measurement; and transmitting, to the SP, a response message including at least one parameter associated with the EAS discovery failure performance measurement.

According to at least one embodiment of the disclosure, an edge enabler server (EES) in an edge network is proved. The EES comprises a memory and a processor. The processor is configured to perform edge application server (EAS) discovery, receive, from a service provider (SP), a request message for EAS discovery failure performance measurement, and transmit, to the SP, a response message including at least one parameter associated with the EAS discovery failure performance measurement.

### Advantageous Effects of Invention

Embodiments of the present disclosure provides methods and apparatus to trigger or request for the instantiation of edge application server (EAS) as a result of a failed EAS discovery procedures.

Embodiments of the present disclosure provides methods and apparatus to determine whether the instantiation of EAS is needed or not based on the EAS discovery failure performance measurement.

### BRIEF DESCRIPTION OF DRAWINGS

This method and devices are illustrated in the accompanying drawings, throughout which like reference letters indicate corresponding parts in the various figures. The embodiments herein will be better understood from the following description with reference to the drawings, in which:

FIG. 1 illustrates an architecture of an edge network device, according to a prior art;

FIG. 2 is a block diagram of an Edge Computing Management System (ECMS) in communication with EES, ASP and ECSP for enhanced edge network management, according to an embodiment as disclosed herein;

FIG. 3 is a sequence diagram illustrating a transmission of a list of dynamic EAS between the EES and a provisioning MnS producer of a management server for the enhanced edge network management, according to an embodiment as disclosed herein;

FIG. 4 is a sequence diagram illustrating the enhanced edge network management by transmitting EAS discovery performance measurements between the EES and the ECSP, according to an embodiment as disclosed herein;

FIG. 5 is a sequence diagram illustrating the enhanced edge network management by transmitting EAS discovery failure notification between the EES and the ECSP, according to an embodiment as disclosed herein;

FIG. 6 is a sequence diagram illustrating the enhanced edge network management by transmitting notify Event message between the EES and the ECSP, according to an embodiment as disclosed herein;

FIG. 7 is a block diagram illustrating a SP for the enhanced edge network management, according to an embodiment as disclosed herein;

FIG. 8 is a block diagram illustrating the EES for the enhanced edge network management, according to an embodiment as disclosed herein;

FIG. 9 is a block diagram illustrating the management server for the enhanced edge network management, according to an embodiment as disclosed herein; and

FIG. 10 is a flow diagram illustrating the enhanced edge network management, according to an embodiment as disclosed herein.

### MODE FOR THE INVENTION

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein provide method for an enhanced edge network management. The method determines an EAS discovery failure at an EES and sending a request message to the EES for a plurality of parameters from the SP. The method further includes receiving a response message comprising the plurality of parameters from the EES and determining a criteria based on the plurality of parameters received from the EES for performing one of initiating the EAS deployment when the criteria is above a predefined range, and dropping the EAS deployment when the criteria is below the predefined range.

In existing systems, an edge application layer architecture requires the EES to trigger or request for instantiation of EAS. Thus, the existing edge network management system lacks ability for the EES to trigger or request for the EAS instantiation.

Unlike existing methods and systems, the EES sends a request for a list of dynamic EAS to a provisioning MnS producer and once the dynamic EAS list is validated the dynamic EAS list is returned to the EES. Based on the dynamic EAS list, the EAS request is modified to initiate EAS deployment.

Unlike the existing methods and systems, the EES provides discovery performance measurements to facilitate the EAS instantiation. The ECSP or ASP creates a PerfMetricJob MOI to request for productions and delivery of the EAS discovery failure measurements per location. The ECSP or ASP send required performance measurements and depending on the performance measurements ECSP or ASP can decide whether the EAS is to be instantiated, with specific capabilities, on a particular location. The ECSP or ASP instantiate EAS deployment process based on the request messages. The PerfMetricJob MOI refers to the Performance Metrics Job Management Object Identifier. The PerfMetricJob MOI is a unique identifier assigned to a Performance Metric Job. The PerfMetricJob MOI collects and reports network performance data to the ECSP or ASP. The PerfMetricJob MOI is used to identify and manage the Performance Metric Job in the 3GPP system, allowing network operators to schedule, monitor, and analyze the performance data collected.

Unlike the existing methods and systems, the EES notifies ECSP or ASP for the need of the EAS instantiation using new notification or using existing notify Event notification.

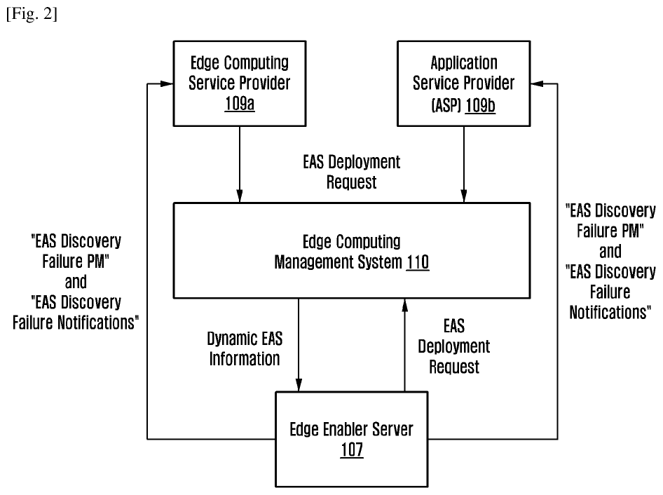

Referring now to the drawings, and more particularly to FIG. 2 through FIG. 10, there are shown preferred embodiments.

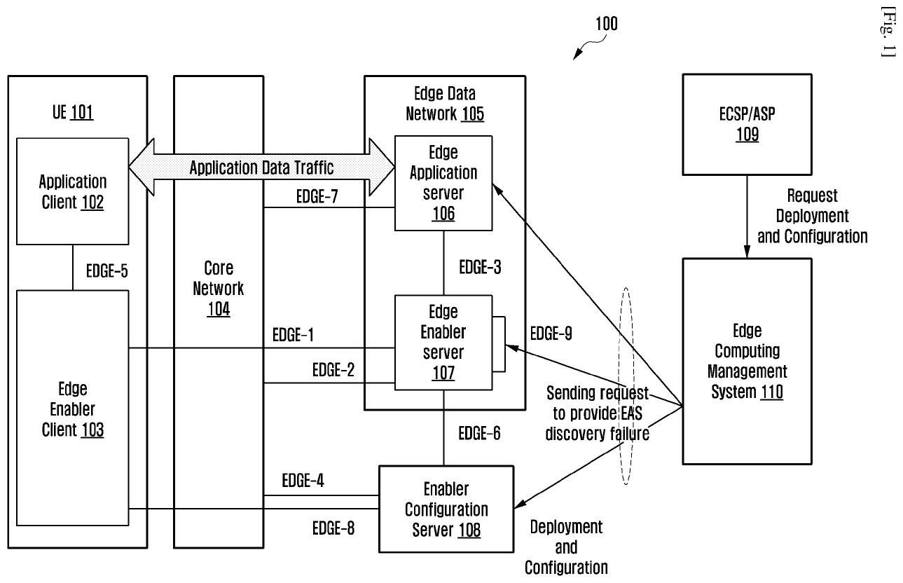

FIG. 1 illustrates an architecture of an edge application architecture (100), according to a prior art. Referring to FIG. 1, the edge application architecture (100), edge management server (100). The edge management server (100) includes a User Equipment (UE) (101), a 3GPP core network (104) or a core network (104), an edge data network (105), an edge configuration server (108), edge computing management system (110) and ECSP or ASP (109).

The UE (101) includes application client (102) and edge enabler client (103) connected with EDGE-5. The core network (104) is connected to the edge data network (105). The edge data network (105) includes an edge application server (106) and an edge enabler server (107). The core network (104) is connected to the edge application server (106) with EDGE-7. The core network (104) is connected to the edge enabler server (107) using EDGE-2. Further, the core network (104) is connected to the edge configuration server (108) using EDGE-4. The edge enabler client (103) is intern connected to both edge enabler server (107) and the edge configuration server (108) using EDGE-1 and EDGE-8 respectively. The edge computing management system (110) is communicatively connected to the edge application server (106), edge enabler server (107) and the edge configuration server (108). The ECSP or ASP (109) is connected to the edge computing management system (110). The ECSP or the ASP (109) can be the service providers (SP) (109). The ECSP or the ASP (109) are referred herein as Service Providers or SP.

The UE (101) can be but not limited to smartphones, tablets, laptops, wearable devices, IoT devices. The application client (102) can be edge applications for performing a specified tasks. The specified tasks can be a messaging, livestreaming and the like. The edge enabler client device (103) communicate with the edge enabler server (107) to receive data and services for the application running on the edge enabler server (107). The edge enabler client device (103) can include a set of libraries and protocols that allow edge devices such as but not limited to EES (107), EAS (106), and edge configuration server (108) to send and receive data. The protocols can include support for common communication protocols such as MQTT, CoAP, or HTTP, as well as more specialized protocols for specific types of devices or applications.

The core network (104) can include but not limited to a Global System for Mobile Communications (GSM), a General Packet Radio Service (GPRS), an Enhanced Data rates for GSM Evolution (EDGE), an Universal Mobile Telecommunications System (UMTS), a High Speed Packet Access (HSPA), a Long-Term Evolution (LTE), and a 5th Generation (5G) network. The EDGE is another extension of the GSM network that improves data transfer rates by using advanced modulation schemes.

The EAS (106) enables the deployment and management of applications at the edge data network (105). The EES (107) facilitate communication between the edge devices and the management servers, providing a standardized way to connect and exchange data. The edge configuration server (108) manage the configuration of edge devices and applications in the edge computing architecture (100). The edge configuration server (108) provides a centralized location for storing and managing configuration data. The configuration data is used to configure and control the behavior of edge devices and applications. The edge devices can be EAS (106), EES (107), ECS (108). The edge configuration server (108) provides a set of APIs and interfaces for configuring edge devices and applications. The set of API can include support for configuring device settings such as but not limited to network parameters, firmware updates, and security settings, as well as application-specific configuration data such as data sources, event triggers, and actions.

The ECSP (109a) is a service provider that offers edge computing services to the client or UE (101), typically through a cloud-based platform. The ECSP (109a) provides infrastructure and function necessary to deploy and manage the edge applications, and can also provide other services such as data storage, data processing, and analytics. An ASP (109b) is a application provider that offers applications to the ECSP (101), typically through a cloud-based platform.

As per the current Edge Application architecture (100), application client (102) sends an EAS discovery request to EES (107) in order to find an appropriate EAS (106) on the edge data network (105). The EES (107) determines the appropriate EAS (106) and return with EAS identifier and point of contact.

The Edge Computing Management System (ECMS) (110) provide a centralized platform to manage edge computing resources such as servers, gateways, sensors, and devices. The ECMS can also manage applications, services, and data processing pipelines deployed on the edge devices. The ECMS (1100 sends a request to provide EAS discovery failures to the EAS (106).

FIG. 2 is a block diagram of ECMS (110) in communication with EES (107) and SP (109) for enhanced edge network management, according to an embodiment as disclosed herein. Referring to FIG. 2, the dynamic EAS information is transmitted from the ECMS (110) to EES and the EAS deployment request is received at the ECMS from the EES (107). The EAS discovery failure performance measurements and EAS discovery failure notifications are received at the edge computing service provider (109a) from the EES. The EAS discovery failure performance measurements and EAS discovery failure notifications are received at the application service provider (109b) from the EES (107). The ECMS (110) receives inputs from edge computing service provider (109a) and application service provider (109b).

The edge computing is a distributed computing platform for computation and data storage to a location where the computation is needed. The edge computing management system (110) manages and monitors components of the edge computing infrastructure, including the edge devices, data storage devices and network.

The edge computing service provider (109a) manages and monitors the edge devices. The edge computing service provider (109a) includes the information about devices located in the edge network, such as IoT devices, sensors, and gateways. The edge computing management system (110) ensures that the devices are properly configured, updated and secured.

The application service provider (109b) stores the applications and related services over internet or a private network. The UE (101) can access the application and related services through the ASP's servers (109b). The ASP (109b) is responsible for hosting, maintaining, and updating the application and providing technical support to the UE (101).

The present disclosure including the edge application architecture (100) requires the EES (107) to trigger the instantiation of the EAS (106) as a result of the failed EAS discovery procedures. The objective of the present disclosure is to enable EES (107) to trigger or request for the EAS deployment. The management server enables the EES (107) to trigger or request the EAS deployment either directly utilizing provisioning MnS or by notifying the 3GPP management system about the EAS discovery failure. The management server (900) decides to initiate EAS deployment appropriately. The EES (107) includes all the required information for the EAS deployment. Therefore, the management server (900) initiate the EAS deployment procedure directly with a generic provisioning MnS.

Alternatively, the EES (107) notify the management server (900) about the need for the particular EAS (106) to be deployed. The management server (900) initiates the EAS deployment procedure utilizing the generic provisioning MnS. The EES (107) can deliver periodic performance information, related to the EAS discovery procedure, to the management server (900). The management server (900) decides whether to initiate the EAS deployment based on performance information or to initiate the deployment of EAS (106) utilizing generic provisioning MnS.

In an embodiment, the EAS discovery failure is determined at the EES. The SP (109) detects the EAS discovery failure at the EES (107). The SP (109) sends a request message to the EES (107) for obtaining various parameters. The various parameters can be an EAS discovery failure performance measurement per location, an EAS discovery failure notification, and notify Event notification. The request message can include, but not limited to an EAS discovery failure performance measurement request, a discovery failure notification request, a notify Event notification request. A response message is received by the SP (109) including criteria based on the various parameters.

The various parameters are received from the EES. The response message includes but not limited to an EAS discovery failure performance measurement response, a discovery failure notification response and a notify Event notification response. The criteria is determined to perform one of initiating the EAS deployment when the criteria is above a predefined threshold and dropping the EAS deployment when the criteria is below the predefined threshold range. The criteria is determined based on the number of EAS discovery failure performance measurement per location, the EAS discovery failure notification, and the notify Event notification.

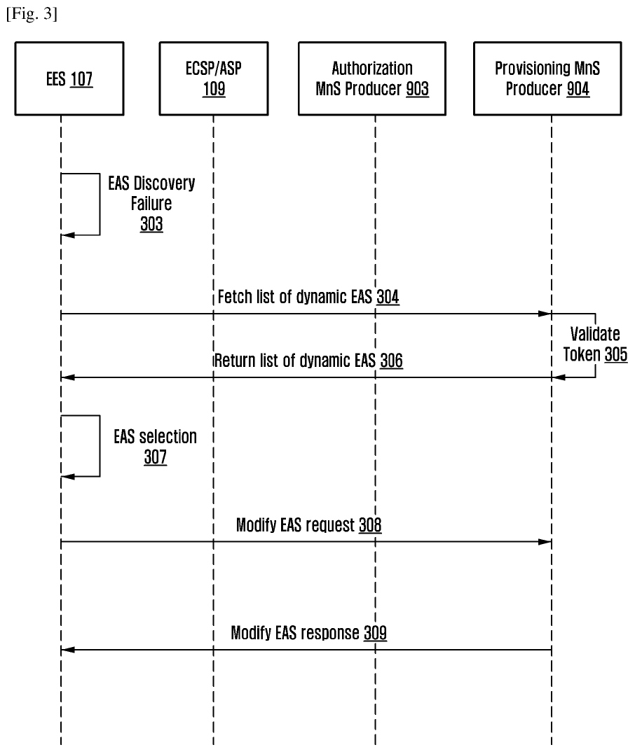

FIG. 3 is the sequence diagram illustrating the transmission of the list of dynamic EAS between the EES (107) and the management server (900) for enhanced edge network management, according to an embodiment as disclosed herein. The network includes the EES (107), the SP (109), the authorization MnS producer (301), and the provisioning MnS producer (302).

At 303, the EES (107) determines the EAS discovery failure. The EAS discovery request is received from the UE. The EAS discovery request is sent from the UE (101) for deployment or instantiation of the applications stored in the management server (900). The EAS discovery is failed at the EES (107).

At 304, the EES (107) transmits the request message to the provisioning MnS producer (903) of the management server (900). The request message can be an authorization to access the provisioning MnS from the provisioning MnS producer (904). The request message can be dynamic EAS. The EES (107) requests to the management server (900) for the information about authorization to access provisioning MnS from provisioning MnS producer (904). The EAS (106) including AvaliabilityStatus=“not installed” and AdministrativeState=“disabled” is transmitted in the dynamic EAS. The EES (107) also transmits related EASRequirement IOC to understand supported feature and capabilities of the EAS in the request message. The EES (107) send getMOIAttributes operation to Provisioning MnS Producer (904). The EES (107) uses an authorization token fetched in previous step (302-304).

At 305, a token is validated. The token validation is a process of verifying an authenticity and validity of a security token. The security token is a digital identity credential that contains information about the user, such as identity, permissions, and access rights. In EES (107) and EAS (106), the token validation is used to ensure that the user attempting to access the application or service has been authenticated and is authorized to access that product or service.

At 306, the response message is transmitted to the EES (107) from the provisioning MnS producer (904) of the management server (900). The response message can be the dynamic EAS. The dynamic EAS (106) includes various parameters including but not limited to AvaliabilityStatus, AdministrativeState and the like. The EES (107) receives the information about the dynamic EAS that is the EAS having AvaliabilityStatus=“not installed” and AdministrativeState=“disabled”. The EES (107) also sends the request for information related EASRequirement IOC to understand the supported feature and capabilities of the EAS (106). For the EES (107) send getMOIAttributes operation to provisioning MnS producer (904). The EES (107) uses the authorization token fetched in previous step (302-305).

TABLE 1
Table 1: States and Status attributes for EASFunction IOC

| Attribute | Support | | | | | | |
|---|---|---|---|---|---|---|---|
| name | Qualifier | isReadable | isWritable | isInvariant | isNotifyable | Description | Properties |
| Operational | M | T | F | F | T | It indicates the | type: ENUM |
| State | | | | | | operational state of the | multiplicity: 1 |
| | | | | | | EAS. It describes | isOrdered: N/A |
| | | | | | | whether or not the | isUnique: N/A |
| | | | | | | resource is physically | defaultValue: None |
| | | | | | | installed and working. | allowedValues: N/A |
| | | | | | | allowedValues: | isNullable: False |
| | | | | | | “ENABLED”, | |
| | | | | | | “DISABLED”. | |
| | | | | | | The meaning of these | |
| | | | | | | values is as defined in | |
| | | | | | | 3GPP TS 28.625 and | |
| | | | | | | ITU-T X.731. | |
| AdministrativeState | M | T | T | F | T | It indicates the | type: ENUM |
| | | | | | | administrative state of the | multiplicity: 1 |
| | | | | | | EAS. It describes the | isOrdered: N/A |
| | | | | | | permission to use or | isUnique: N/A |
| | | | | | | prohibition against | defaultValue: |
| | | | | | | using EAS instance, | LOCKED |
| | | | | | | imposed through the | allowedValues: N/A |
| | | | | | | OAM services. | isNullable: False |
| | | | | | | allowedValues: | |
| | | | | | | “LOCKED”, | |
| | | | | | | “UNLOCKED”, | |
| | | | | | | SHUTTINGDOWN” | |
| | | | | | | The meaning of these | |
| | | | | | | values is as defined in | |
| | | | | | | 3GPP TS 28.625and | |
| | | | | | | ITU-T X.731. | |
| Avaliability | M | | T | F | T | It indicates the | type: ENUM |
| Status | | | | | | availability status of | multiplicity: 1 . . .* |
| | | | | | | the EAS. The value | isOrdered: False |
| | | | | | | “Not Installed” | isUnique: True |
| | | | | | | indicate that the EAS | defaultValue: None |
| | | | | | | is not completely | allowedValues: N/A |
| | | | | | | installed and hence | isNullable: True |
| | | | | | | not utilizing any | |
| | | | | | | underlining virtual | |
| | | | | | | resources. | |
| | | | | | | allowedValues: “In | |
| | | | | | | test”, “Failed”, “Power | |
| | | | | | | off”, “Off line”, “Off | |
| | | | | | | duty”, “Dependency”, | |
| | | | | | | “Degraded”, “Not | |
| | | | | | | installed”, “Log full”. | |
| | | | | | | The meaning of these | |
| | | | | | | values is as defined in | |
| | | | | | | 3GPP TS 28.625 and | |
| | | | | | | ITU-T X.731. | |

At 307, the EES (107) decides whether to select the EAS (106) based on the list of dynamic EAS. The EAS (106) can be selected based on the parameters received from the provisioning MnS producer (904) of the management server (900).

At 308, the EAS request is modified based on the parameters received at the EES (107). The EES (107) request to change the AvaliabilityStatus=“installed” and AdministrativeState=“enabled”. The EES (107) uses modifyMOIAttributes operation for changing the EES (107) request. The EES (107) sends the request message to the provisioning MnS producer (904) for changing the EAS request. The change in the EAS request can be AvaliabilityStatus=“installed” and AdministrativeState=“enabled”.

At 309, the provisioning MnS producer (904) transmits the response message to the EES (107). The response message includes changed EAS request status. A new EASrequest status can be AvaliabilityStatus=“installed” and AdministrativeState=“enabled”.

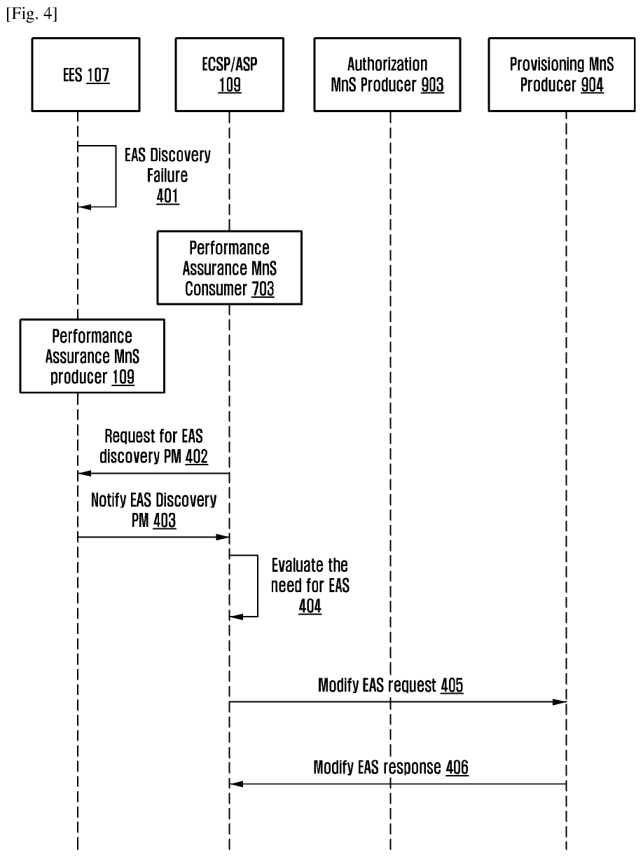

FIG. 4 is a sequence diagram illustrating enhanced edge network management by transmitting an EAS discovery performance measurement between the EES (107) and the SP (109), according to an embodiment as disclosed herein.

At 401, the EES (107) determines the EAS discovery failure. The EAS discovery request is received from the UE (101). The EAS discovery request is sent from the UE (101) for deployment or instantiation of the applications stored in the management servers (900).

At 402, the createMOI (PerfMetricJob) request message is transmitted to the EES (109) from the SP (109). The request message includes parameters for instance but not limited to the EAS discovery failure performance measurement per location. The request message is transmitted from the performance assurance MnS consumer (703) of the SP (107) to the performance assurance MnS producer (803) of the EES (109). The SPs (109) can be, but not limited to ECSP (109a) and ASP (109b).

At 403, the SP (109) receives the response message corresponding to the EAS discovery performance measurement request message from the EES (107). The SP (109) receives the response message including, but not limited to the parameter measurement per location for instantiating the EAS (106) based on the response message.

In an embodiment, the response message includes paremeters associated with EAS discovery failure performance measurement, and EAS discovery failure performance measurement is as follows:
This measurement provides the number of EAS discovery requests (see clause 8.5.2 of TS 23.558 [52]) rejected by the EES.
CC
On transmission of each unsuccessful EAS Discovery Response (see clause 8.5.2 of TS 23.558 [52]) by the EES with the HTTP response code of 400/01/03/04/06/09/11/12/13/14/15/429. Each rejected request is added.
Each subcounter is an integer value
The measurement name has the form DIS.EasDisFail.Filter, where Filter is a combination of the attributes for EasDiscoveryFilter as defined in 24.558.
EESFunction
Valid for packet switched traffic
5G
One usage of this performance measurement is for EES performance assurance.

At 404, the criteria is determined for evaluating the EAS (106) based on the parameters received from the EES (107). When the criteria is above the predefined range then the EAS deployment is initiated. When the criteria is below the predefined range then the EAS deployment is dropped. The criteria is determined based on, but not limited to the number of EAS discovery failure per location. When EAS discovery failure happen more than a predefined number of times for a given location, then the EAS deployment is initiated using the existing EAS deployment methods. The predefined range can be dynamic and vary based on parameters such as but not limited to geographic area, footfalls and the like.

At step 405, the EAS deployment request is transmitted to the provisioning MnS producer (904) of the management server (900) to instantiate the EAS. The management server (900) can be remotely coupled to the service providers.

At 406, the response message is transmitted to the service provider (109). The response message is for the deployment of the EAS.

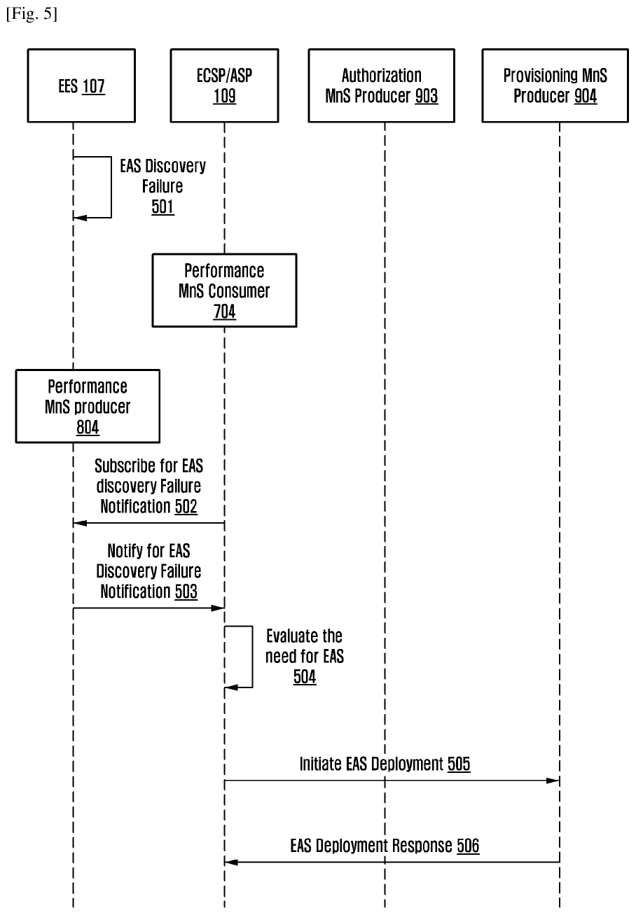

FIG. 5 is the sequence diagram illustrating enhanced edge network management by transmitting EAS discovery failure notification between the EES (107) and the SP (109), according to an embodiment as disclosed herein.

At 501, the EES (107) determines the EAS discovery failure. The EAS discovery request is received from the UE. The EAS discovery request is sent from the UE (101) for deployment or instantiation of the applications stored in the management servers (900).

At 502, the createMOI (NtfSubscriptionCtrl) request message is transmitted to the provisioning MnS producer (804) of the EES (107). The request message can be but not limited to the subscription request for EAS discovery failure notification. The request message uses NtfSubscriptionControl fragment. The NtfSubscriptionControl represents a notification subscription of a notification recipient. The NtfSubscriptionControl can be name contained by SubNetwork or ManagedE.

To receive notifications, a MnS consumer creates an NtfSubscriptionControl instance on the MnS producer. When a MnS consumer does not wish to receive notifications any more the MnS consumer shall delete the corresponding NtfSubscriptionControl instance.

At 503, depending on the parameters provided in the request message, the subscription response for EAS discovery failure notification can be used to decide whether to instantiate the EAS, with specific capabilities (as defiend in 3GPP TS 23.558), on a particular location. The request message can be, but not limited to subscription request for EAS discovery failure notification. The response message can be, but not limited to notification for the EAS discovery failure notification (503). The response message is transmitted from the EES (107) to the SP (109) including EAS discovery failure notification.

At 504, the criteria is determined to evaluate the EAS (106) based on the parameters received from the EES (107). When the criteria is above a predefined range then the EAS deployment is initiated. When the criteria is below the predefined range then the EAS deployment is dropped. The criteria is determined based on, but not limited to the number of EAS discovery failure the EAS discovery failure notification. When EAS discovery failure happen more than a predefined number of time for a given location, then the EAS deployment is initiated using the existing EAS deployment methods.

The notification notifyEASDiscoveryFailure notifies that the subscribed consumer that an EAS Discovery Failure is occurred.

The notification includes the following parameters:
a. objectClass: specifies the class name of the EESFunction. The EAS discovery failure event occurred in an instance of the EESFunction class. The event carries Man-agedEntity class name.
b. objectInstance: specifies an instance of EESFunction IOC in which the EAS discovery failure event has occurred. The event carry the Distinguished Name (DN) for the instance.
c. notificationID: is an identifier for the notification that can be used to correlate notifications. The identifier of the notification shall be chosen to be unique across all notifications of a particular managed object instance throughout the time that correlation is significant. The identifier uniquely identifies the notification from other notifications generated by the subject MOI.
d. notificationType: notifyEASDiscoveryFailure.
e. eventTime: time at which the discovery failure has occurred.
f. easDiscoveryFilters: the requirements submitted as part of EAS Discovery Filters are as defined in 3GPP.

At step 505, the EAS deployment request is transmitted to the provisioning MnS producer (903) of the management server (900) to instantiate the EAS. The management server (900) can be remotely coupled to the SP (109).

At 506, the response message is transmitted to the SP (109). The response message is for the deployment of the EAS.

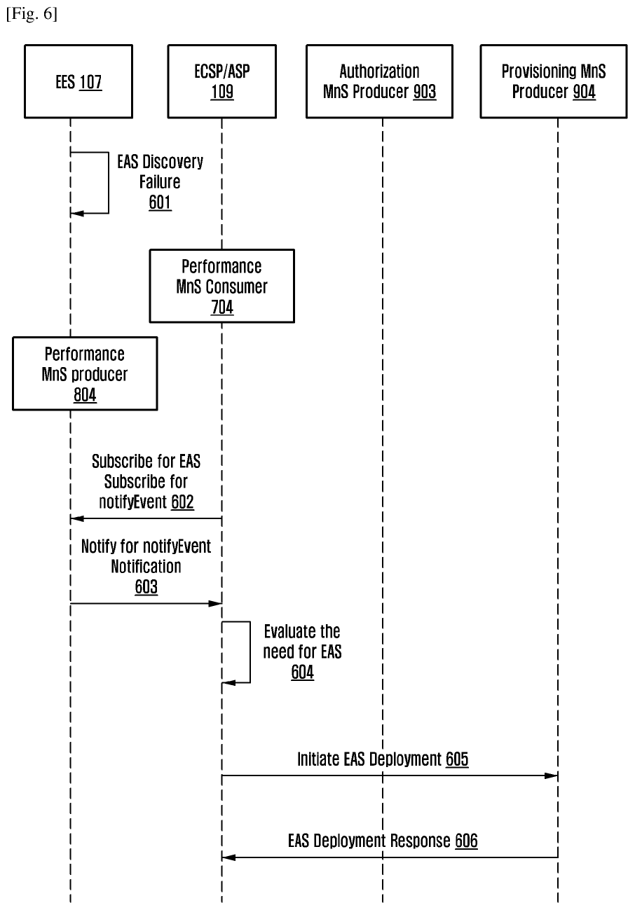

FIG. 6 is the sequence diagram illustrating enhanced edge network management by transmitting the notify Event message between the EES (107) and the SP (109), according to an embodiment as disclosed herein;

At 601, the EES (107) determines the EAS discovery failure. The EAS discovery request is received from the UE (101). The EAS discovery request is sent from the UE (101) for deployment or instantiation of the applications stored in the management servers (900).

At 602, the request message is transmitted to the EES (107) by the SP (109) acting as a provisioning MnS consumer (704). The request message can include a subscription for notifyEvent.

The notification notifyEvent is used as defined in 3GPP with the exceptions as described further.

The new attribute named “easDiscoveryFailureInfo” is defined. The attribute is a type <<EASDiscoveryFailureInfo>> and will contain the EAS Discovery Filter provided in the EAS Discovery Request or the attribute “specifcProblem” is extended to be as ENUM with values of “EASDISFAILURE” or “EASDISSUCCESS”.

An attribute “easDiscoveryFailureInfo” is defined to contain all the EAS Discovery Filter as defined in the 3GPP. The attribute can be conditional mandatory on the presence of “specifcProblem” with value “EASDISFAILURE”.

At 603, the SP (109) receives the notification including the notifyEvent to the provisioning MnS consumer (704).

At 604, the criteria is determined for evaluating the EAS (106) based on the parameters received from the EES (107). When the criteria is above the predefined range then the EAS deployment is initiated. When the criteria is below the predefined range then the EAS deployment is dropped. The criteria is determined based on, but not limited to the notifyEvent notification. When EAS discovery failure happen more than a predefined number of time for a given location, then the EAS deployment is initiated using the existing EAS deployment methods.

At step 605, the EAS request message is transmitted to the provisioning MnS producer (904) of the management server (900). The management server (900) can be remotely coupled to the SP (109).

At 606, the response message is transmitted to the SP (109). The response message is for the deployment of the EAS (106).

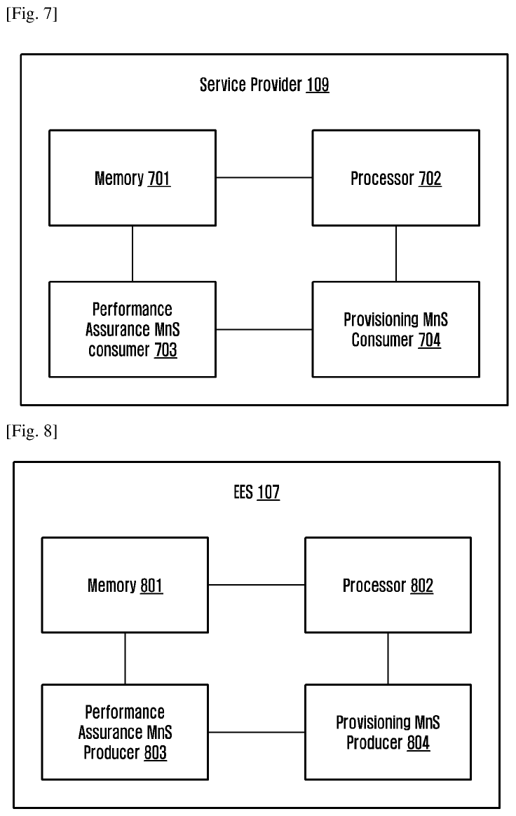

FIG. 7 is a block diagram illustrating the SP (109) for enhanced edge network management, according to the embodiment as disclosed herein. The SP (109) can be ECSP (109a) and ASP (109b). The SP (109) can include but not limited to a memory (701), a processor (702), the performance assurance MnS consumer (703), and the provisioning MnS consumer (704).

The memory (701) includes storage locations to be addressable through the processor (702). The memory (701) are not limited to a volatile memory and/or a non-volatile memory. Further, the memory (701) can include one or more computer-readable storage media. The memory (701) can include non-volatile storage elements. For example non-volatile storage elements can include magnetic hard discs, optical discs, floppy discs, flash memories, or forms of electrically programmable memories (EPROM) or electrically erasable and programmable (EEPROM) memories.

The processor (702) communicates with the memory (701), the performance assurance MnS consumer (703), and provisioning MnS consumer (704). The processor (702) is configured to execute instructions stored in the memory (701) and to perform various processes. The processor (702) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The performance assurance MnS consumer (703) configured for communicating in-ternally between internal hardware components and with external devices via one or more networks. The external device can be the EES (107). The performance assurance MnS consumer (703) includes an electronic circuit specific to a standard that enables wired or wireless communication. The performance assurance refers to ability to ensure that a system or device is meeting intended performance standards. In the case of edge devices, factors such as response time, throughput, and availability. Consumer likely refers to the UE (101) or customer of the edge device. The performance assurance MnS consumer (703) in the edge device can be the ability of a Managed and Support Services provider to ensure that the management server (900) is meeting the intended performance standards for the end user or the UE (101). Monitoring can include monitoring the device for performance issues, troubleshooting and resolving issues, and providing ongoing support to ensure that the device continues to perform as expected.

The provisioning MnS consumer (704) in the EES (107) involves configuring the server to allow the MnS consumer to access the data for monitoring and support. The steps to provision a MnS consumer in the EES (107) is depending on the specific server and MnS consumer generally include the following:
Identify the MnS consumer: determine the MnS consumer provisioning the EES (107).
Obtain credentials: obtaining necessary credentials from the MnS consumer to access the management server. The credentials can include, but not limited to a username, password, API key, or other authentication tokens.
Configure access permissions: configuring the server's access permissions to allow the MnS consumer to access the data for monitoring and support. The configuration can involve creating a new user account for the MnS consumer or granting access permissions to an existing user account.
Test the connection: testing the connection between the EES (107) and the MnS consumer to ensure that data can be successfully transferred.
Monitor and maintain: monitoring the MnS consumer's access to the EES (107) to ensure the EES (107) is functioning properly.

The provisioning a MnS consumer (704) in the EES (107) requires careful planning, configuration, and monitoring to ensure that the server remains secure and functional while allowing the MnS consumer to access required data.

FIG. 8 is a block diagram illustrating an EES (107) for enhanced edge network management, according to the embodiment as disclosed herein. Referring to FIG. 8, includes a memory (801), a processor (802), the performance assurance MnS producer (803), and the provisioning MnS producer (804).

The memory (801) includes storage locations to be addressable through the processor (802). The memory (801) are not limited to a volatile memory and/or a non-volatile memory. Further, the memory (801) can include one or more computer-readable storage media. The memory (801) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories.

The processor (802) communicates with the memory (801), the performance assurance MnS producer (803), and provisioning MnS producer (804). The processor (802) is configured to execute instructions stored in the memory (801) and to perform various processes. The processor (802) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The performance assurance MnS producer (803) collect data from the management server (900) or from the SP (109) being monitored and providing the data to the MnS consumer. The producer can be an agent, service, or component that runs on the EES (107). The producer monitors and collects performance metrics including but not limited to log data, relevant information about the system's behavior. The performance assurance MnS consumer (703) analyzes the data provided by the MnS producer and generating reports, alerts, or other outputs based on that data. The consumer can be, but not limited to a dashboard or other monitoring tool that aggregates and displays the performance metrics, log data, and information provided by the MnS producer. The performance assurance MnS producer (803) is responsible for collecting data from the system being monitored, while the performance assurance MnS consumer (703) is responsible for analyzing and interpreting that data to identify issues and optimize system performance.

The provisioning MnS producer (804) refers to the process of configuring the MnS Producer component or application to collect and transmit performance data from the management server (900) to the MnS consumer. The MnS producer is responsible for collecting data from the management server (900) or the SP (109) monitored and providing to the MnS consumer. The MnS producer can be an agent, service, or component that runs on the management server being monitored and collects performance metrics including, but not limited to log data, and relevant information. The provisioning MnS producer (804) involves setting up the MnS producer application or tool to collect the appropriate data and transmit the data to the MnS consumer. On the other hand, provisioning MnS consumer (704) refers to the process of configuring the MnS consumer component or application to receive and analyze the performance data provided by the MnS producer. The MnS consumer is responsible for analyzing the data provided by the MnS producer and generating reports, alerts, or other outputs based on that data. The MnS consumer can be, but not limited to the dashboard or monitoring tool that aggregates and displays the performance metrics, log data, and the information provided by the MnS producer. The provisioning MnS consumer (704) involves setting up the MnS consumer application or tool to receive and analyze the data provided by the MnS producer. The provisioning MnS producer (804) is the process of configuring the MnS producer component to collect and transmit performance data, while provisioning MnS consumer (704) is the process of configuring the MnS consumer component to receive and analyze the data provided by the MnS Producer.

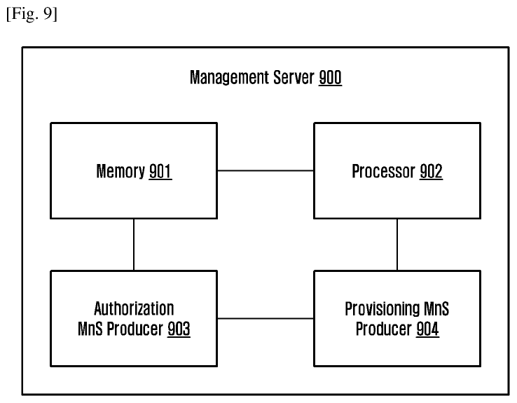

FIG. 9 is the block diagram illustrating the management server (900) for enhanced edge network management, according to an embodiment as disclosed herein. The management server (900) includes a memory (901), processor (902), an authorization MnS producer (903), and a provisioning MnS producer (904).

The memory (901) includes storage locations to be addressable through the processor (902). The memory (901) are not limited to a volatile memory and/or a non-volatile memory. Further, the memory (901) can include one or more computer-readable storage media. The memory (901) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories.

The processor (902) communicates with the memory (801), the authorization MnS producer (903), and the provisioning MnS producer (904). The processor (902) is configured to execute instructions stored in the memory (901) and to perform various processes. The processor (902) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The authorization MnS producer (903), authorization for the MnS producer involves setting up appropriate access controls and permissions to ensure that the producer has the necessary access to collect and transmit performance data from the management server, while also ensuring that sensitive information is protected and access is re-stricted only to authorized users.

The provisioning MnS producer (904) provisioning MnS producer (904) refers to the process of setting up and configuring an MnS (Monitoring and Support) producer component or application to collect and transmit performance data from the management system (900). In an MnS scenario, the MnS producer is responsible for collecting performance metrics, log data, and other relevant information about the system's behavior involving installing the agent or component on the system being monitored, configuring to collect the appropriate data, and transmitting that data to the MnS Consumer for analysis and reporting. The provisioning process for an MnS Producer typically involves the following steps:
Identify the system or systems to be monitored: The first step in provisioning an MnS Producer is to identify the system or systems that need to be monitored. This may include servers, applications, databases, or network devices.
Select the appropriate MnS Producer tool or agent: Once the systems have been identified, the next step is to select the appropriate MnS Producer tool or agent to collect performance data from those systems. There are many MnS Producer tools available, including open-source and commercial options, and the selection should be based on the specific requirements of the organization.
Install and configure the MnS Producer tool or agent: After selecting the appropriate MnS Producer tool or agent, the next step is to install it on the system or systems being monitored. The agent or tool must be configured to collect the appropriate data and transmit it to an MnS Consumer for analysis.
Test and validate the MnS Producer: Once the MnS Producer has been installed and configured, it should be tested and validated to ensure that it is collecting the appropriate data and transmitting it to the MnS Consumer correctly. This may involve running test scripts or simulations to generate performance data and verifying that it is being collected and transmitted correctly.
Monitor and maintain the MnS Producer: Finally, the MnS Producer must be monitored and maintained to ensure that it continues to function correctly over time. This may involve periodic updates to the agent or tool, as well as troubleshooting and maintenance as needed.

The provisioning MnS producer involves selecting, activating, and configuring the MnS Producer tool or agent to collect and transmit performance data from the management server (900) for analysis by thex MnS Consumer.

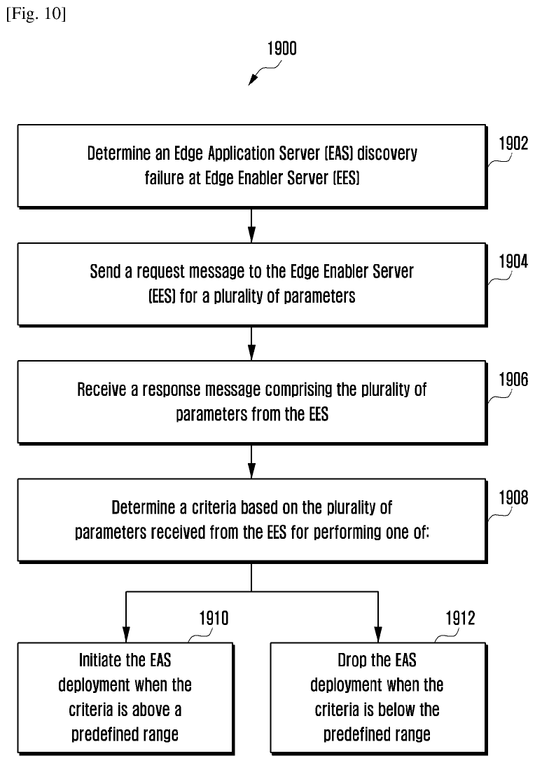

FIG. 10 is the flow diagram illustrating enhanced edge network management (1900), according to an embodiment as disclosed herein.

At 1902, the EAS discovery failure at the EES (107) is determined.

At 1904, the request message is sent to the EES (107) for the parameters.

At 1906, the response message including parameters are received from the EES (107).

At 1908, the criteria is determined based on the parameters received from the EES (107) for performing one of steps 1910 or 1912.

At 1910, the EAS deployment is initiated when the criteria is above a predefined range.

At 1912, the EAS deployment is dropped when the criteria is below the predefined range.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

The invention claimed is:

1. A method performed by a service provider (SP) in an edge network, the method comprising:
transmitting, to an edge enabler server (EES), a request message for edge application server (EAS) discovery failure performance measurement;
receiving, from the EES, a response message including at least one parameter associated with the EAS discovery failure performance measurement;
determining whether an instantiation of the EAS is needed or not based on the at least one parameter; and
in case that the instantiation of the EAS is needed, performing instantiation of the EAS.

2. The method of claim 1, wherein the at least one parameter includes subcounter of a user equipment (UE) location.

3. The method of claim 1, wherein the at least one parameter includes a number of EAS discovery failures.

4. The method of claim 3, wherein the number of EAS discovery failures is incremented on transmission of EAS discovery response indicating EAS discovery failure.

5. The method of claim 1, wherein the at least one parameter includes DIS.EasDisFail.Filter, wherein the DIS.EasDisFail.Filter is associated with the EAS discovery filter.

6. A service provider (SP) in an edge network, the SP comprising:
a memory; and
a processor configured to:
transmit, to an edge enabler server (EES), a request message for edge application server (EAS) discovery failure performance measurement, receive, from the EES, a response message including at least one parameter associated with the EAS discovery failure performance measurement,
determine whether an instantiation of the EAS is needed or not based on the at least one parameter, and
in case that the instantiation of the EAS is needed, perform instantiation of the EAS.

7. The SP of claim 6, wherein the at least one parameter includes subcounter of a user equipment (UE) location.

8. The SP of claim 6, wherein the at least one parameter includes a number of EAS discovery failures.

9. The SP of claim 8, wherein the number of EAS discovery failures is incremented on transmission of EAS discovery response indicating EAS discovery failure.

10. The SP of claim 6, wherein the at least one parameter includes DIS.EasDisFail.Filter, wherein the DIS.EasDisFail.Filter is associated with the EAS discovery filter.

11. A method performed by an edge enabler server (EES) in an edge network, the method comprising:
performing edge application server (EAS) discovery;
receiving, from a service provider (SP), a request message for EAS discovery failure performance measurement; and
transmitting, to the SP, a response message including at least one parameter associated with the EAS discovery failure performance measurement.

12. The method of claim 11, wherein the at least one parameter includes subcounter of a user equipment (UE) location.

13. The method of claim 11, wherein the number of EAS discovery failures is incremented on transmission of EAS discovery response indicating EAS discovery failure.

14. An edge enabler server (EES) in an edge network, the EES comprising:
a memory; and
a processor configured to:
perform edge application server (EAS) discovey,
receive, from a service provider (SP), a request message for EAS discovery failure performance measurement, and
transmit, to the SP, a response message including at least one parameter associated with the EAS discovery failure performance measurement.

15. The EES of claim 14, wherein the number of EAS discovery failures is incremented on transmission of EAS discovery response indicating EAS discovery failure.
